(19) United States
(12) Patent Application Publication
(10) Pub. No.: US 2026/0244964 A1
(43) Pub. Date: Aug. 20, 2026

(54) Configurable Qubit Electronics with Wide Output Range

(71) Applicant: International Business Machines Corporation, Armonk, NY (US)

(72) Inventors: Timothy LINDQUIST, Rochester, MN (US); Jarrett BETKE, Hoffman Estates, IL (US); George Russell ZETTLES, IV, Rochester, MN (US); Scott M. WILLENBORG, Stewartville, MN (US); Brian David ALLISON, Rochester, MN (US); Jeremy T EKMAN, West Concord, MN (US); Matthew A. WALTHER, Rochester, MN (US)

(21) Appl. No.: 18/526,090

(22) Filed: Dec. 1, 2023

(51) Int. Cl. G06N 10/40

(52) U.S. Cl. CPC G06N 10/40

(57) ABSTRACT

A system comprises a memory that stores and a processor that executes computer executable components stored in the memory, wherein the computer executable components comprise a selection component that, on a per qubit basis, defines a resonating frequency (RF), wherein the RF is selected to correspond to a qubit of a quantum system, a configuration component that directs setting of an operating frequency (OF) of an oscillator of qubit control electronics, associated with the qubit, based on the RF, and a digital to analog converter (DAC), of the qubit control electronics, that determines an intermediate frequency (IF) for an IF signal that combined with the OF of the oscillator enables generation of an RF signal having the RF.

### BACKGROUND

In quantum computing systems, quantum processors can comprise a plurality of qubits, such as in the hundreds or in the future, in the thousands, millions or even billions. Qubits can have a respective resonant frequencies. Qubits can be associated with qubit control electronics, such as individual qubit control electronics, that can operate relative to the respective resonant frequencies of the qubits.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for control of a quantum payload having increasingly large numbers of qubits and/or having an increasingly large resonant frequency range.

In accordance with an embodiment, a system can comprise a memory that stores and a processor that executes computer executable components stored in the memory, wherein the computer executable components comprise a selection component that, on a per qubit basis, defines a resonating frequency (RF), wherein the RF is selected to correspond to a qubit of a quantum system, a configuration component that directs setting of an operating frequency (OF) of an oscillator of qubit control electronics, associated with the qubit, based on the RF, and a digital to analog converter (DAC), of the qubit control electronics, that determines an intermediate frequency (IF) for an IF signal that combined with the OF of the oscillator enables generation of an RF signal having the RF.

In accordance with another embodiment, a computer-implemented method can comprise on a per qubit basis, defining, by a system operatively coupled to a processor, a resonating frequency (RF), wherein the RF is selected to correspond to a qubit, directing, by the system, setting of an operating frequency (OF) of an oscillator of the qubit control electronics based on the RF, and determining, by the system, an intermediate frequency (IF) for an IF signal that combined with the OF of the oscillator enables generation of an RF signal at the RF.

In accordance with still another embodiment, a computer program product facilitating a process to control a quantum payload comprising a qubit, the computer program product comprising a computer readable storage medium having program instructions embodied therewith, the program instructions executable by a processor to cause the processor to on a per qubit basis, define, by the processor, a resonating frequency (RF), wherein the RF is selected to correspond to the qubit, direct, by the processor, setting of an operating frequency (OF) of an oscillator of the qubit control electronics based on the RF, and determine, by the processor, an intermediate frequency (IF) for an IF signal that combined with the OF of the oscillator enables generation of an RF signal at the RF.

A benefit of the system, computer-implemented method and/or computer program product can be an ability to, during quantum system setup, configure qubit control electronics to function with qubits having varying resonant frequencies, including atypical frequencies. This setup of the qubit control electronics can be provided while also employing resonant frequency outputs from the control electronics that can allow for adequate sampling, sufficient to determine accurate qubit states. That is, signals sent from and obtained by qubit control electronics can have better spectral content and reduced extraneous harmonic peaks than those sent from and obtained by qubit control electronics setup using existing frameworks.

Another benefit of the system, computer-implemented method and/or computer program product can be an ability to employ a digital to analog converter (DAC) comprising a built-in oscillator, such as a free running numerically controlled oscillator (NCO).

As used herein, above and below, the term “free running” refers to continuous running with respect to a quantum experiment instruction set, as opposed to running only when directed relative to the quantum experiment instruction set.

Yet another benefit of the system, computer-implemented method and/or computer program product can be an ability to obtain improved performance of a larger quantity of qubits of a single quantum system that is possible using existing frameworks. This improved performance can be obtained over a wider qubit resonant frequency range, thus allowing for more headroom for future larger quantum payloads.

### DESCRIPTION OF THE DRAWINGS

FIG. 1 illustrates a block diagram of an example, non-limiting system that can provide a process to manage qubit control electronics of a quantum system, in accordance with one or more embodiments described herein.

FIG. 2 illustrates a block diagram of another example, non-limiting system that can provide a process to manage qubit control electronics of a quantum system, in accordance with one or more embodiments described herein.

FIG. 3 illustrates a block diagram of a quantum system that can be employed in connection with the non-limiting systems of FIGS. 1 and 2, in accordance with one or more embodiments described herein.

FIG. 4 provides a schematic illustration of a portion of the quantum system of FIG. 3, in accordance with one or more embodiments described herein.

FIG. 5 provides another schematic illustration of a portion of the quantum system of FIG. 3, in accordance with one or more embodiments described herein.

FIG. 6 illustrates a graph of intermediate frequency versus resonating frequency, demonstrating a process that can be performed by the non-limiting system of FIG. 2, in accordance with one or more embodiments described herein.

FIG. 7 illustrates a graph demonstrating the Nyquist limit in relation to the non-limiting system of FIG. 2, in accordance with one or more embodiments described herein.

FIG. 8 illustrates a pair of exemplary graphs in the frequency domain, in relation to resonating frequencies that can be output by a digital to analog converter of the non-limiting system of FIG. 2, in accordance with one or more embodiments described herein.

FIG. 9 illustrates a flow diagram of one or more processes that can be performed by the non-limiting system of FIG. 2, to control qubit control electronics employing a digital to analog converter having a built-in oscillator, in accordance with one or more embodiments described herein.

FIG. 10 illustrates a continuation of the flow diagram of FIG. 9 of one or more processes that can be performed by the non-limiting system of FIG. 2, in accordance with one or more embodiments described herein.

FIG. 11 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In practice, quantum processors can comprise a plurality of qubits, such as in the hundreds, or in the future, in the thousands, millions and/or even billions. Each qubit can be associated with one or more qubit control electronics, such as a qubit control card, qubit acquire card and/or qubit drive card. Initial setup of such qubit control electronics, also herein referred to as quantum control electronics, of a quantum system having a quantum payload comprising a plurality of qubits, can comprise setup of such qubit control electronics relative to particular resonant frequencies of qubits of the quantum payload.

However, setup of qubit control electronics for controlling tens, hundreds, thousands, millions or even billions of qubits using existing frameworks can be impossible and/or can result in readouts having low spectral content and/or low resolution, undersampling of frequencies thus approaching an undesirable Nyquist rate, generation of qubit acquire and/or drive control waveforms having too few samples, and/or loss of information contained within a signal, without being limited thereto.

Accordingly, to account for one or more of these deficiencies of existing qubit control electronics setup frameworks for quantum systems, one or more embodiments described herein can provide for identification of a resonant frequency of a qubit, configuration of an operating frequency (OF) of an oscillator of the qubit control electronics based on the resonant frequency, and/or calculation of an intermediate frequency (IF) for an IF signal that combined with the OF of the oscillator enables generation of a resonating frequency (RF) signal having the RF. As used herein, the RF is a radio frequency pulse that is made by combining the IF with the OF,

As such, the one or more embodiments herein can provide for automatic or at least partially automatic setup of qubit control electronics for controlling a qubit/operating with a readout resonator, and further being based on a resonant frequency of the qubit. Likewise, the one or more embodiments herein can provide for automatic control of launching of IF signals relative to a free running NCO, whether for execution of a quantum circuit, calibration, etc.

As used herein, the term “information” can comprise data and/or metadata in any suitable form, code and/or language.

As used herein, the term “data” can comprise metadata.

As used herein, the terms “entity,” “requesting entity,” and “user entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

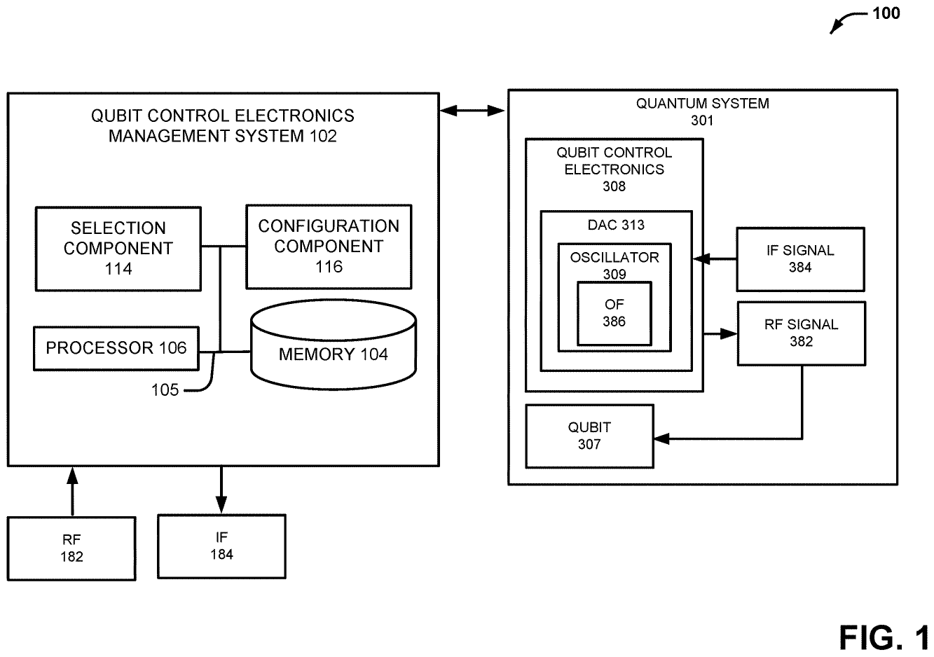

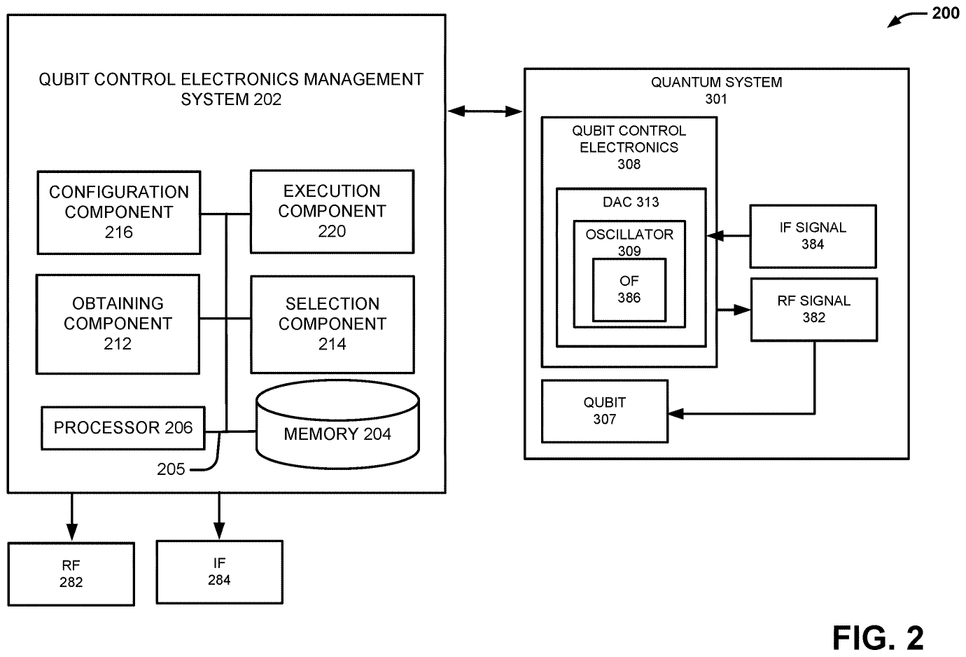

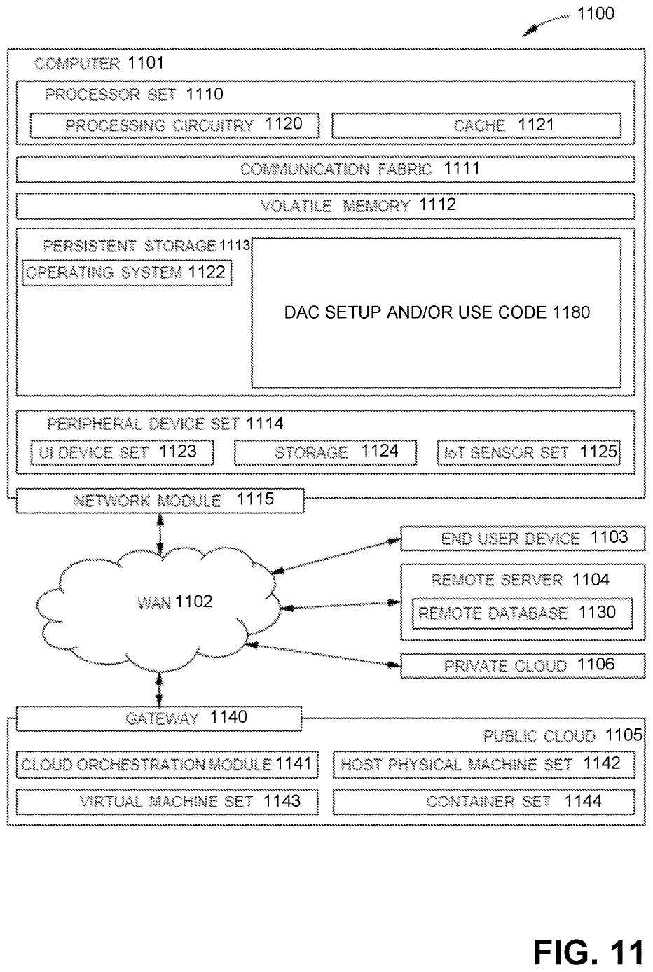

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1100 illustrated at FIG. 11. In one or more described embodiments, computer and/or computing-based elements can be used in connection with implementing one or more of the systems, devices, components and/or computer-implemented operations shown and/or described in connection with FIGS. 1 and/or 2 and/or with one or more other figures described herein.

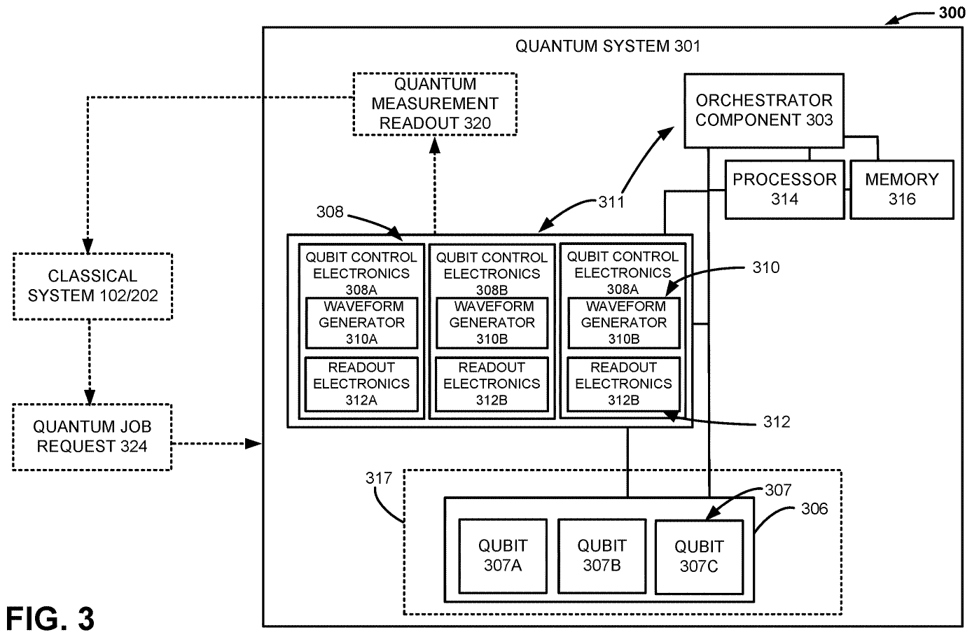

Turning now in particular to one or more figures, and first to FIG. 1, the figure illustrates a block diagram of an example, non-limiting system 100 that can facilitate setup of quantum system resources, such as qubit control electronics 308, of a quantum system 301 (FIG. 3).

The non-limiting system 100 can comprise a qubit control electronics management system 102 and a quantum system 301, to be described in detail below. It is noted that the qubit control electronics management system 102 is only briefly described relative to FIG. 1 to provide but a lead-in to description of a more complex and/or more expansive qubit control electronics management system 202 as illustrated at FIG. 2. That is, further detail regarding processes that can be performed by one or more embodiments described herein will be provided below relative to the non-limiting system 200 of FIG. 2.

Still referring to FIG. 1, the qubit control electronics management system 102 can comprise at least a memory 104, bus 105, processor 106, selection component 114 and/or configuration component 116. Using these components and a digital to analog converter (DAC) 313 of the quantum system 301, the qubit control electronics management system 102 can provide for setup of system resources, and/or use of the system resources, such as qubit control electronics 308 comprising the DAC 313, at the quantum system 301, allowing for control of qubits 307 and/or readout resonators associated with the qubits 307 of the quantum system 301.

Generally, the selection component 114 can on a per qubit basis, define a resonating frequency (RF) 182, wherein the RF 182 is selected to correspond to a qubit 307. As used here, “to correspond to” can comprise direct correspondence to a qubit resonating frequency of the qubit 307 or to a readout resonator resonating frequency of a readout resonator associated with the qubit 307. That is, the RF 182 selected can, after being generated, be transmitted to qubit control electronics 308 to perform one or more driving operations and/or acquiring operations at and/or relative to the qubit 307.

However, first, the configuration component 116 generally can direct setting of an operating frequency (OF) 386 of an oscillator 309 of the qubit control electronics 308 based on the RF 182.

The DAC 313 generally can determine an intermediate frequency (IF) 184 for an IF signal 384 that combined with the OF 386 of the oscillator 386 enables generation of an RF signal 382 having the RF 182.

It is noted that the selection component 114 and/or the configuration component 116 can operate at a classical system of and/or comprising the qubit control electronics management system 102.

In general, the non-limiting system 100 can employ any suitable method of communication (e.g., electronic, communicative, internet, infrared, fiber, etc.) to provide communication between the qubit control electronics management system 102 and the quantum system 301.

Turning next to FIG. 2, a non-limiting system 200 is illustrated that can comprise a qubit control electronics management system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 that can facilitate setup of quantum system resources, such as qubit control electronics 308, of a quantum system 301 (FIG. 3).

Turning first to the qubit control electronics management system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The qubit control electronics management system 202 can be associated with, such as accessible via, a cloud computing environment.

The qubit control electronics management system 202 can comprise a plurality of components. The components can comprise a memory 204, processor 206, bus 205, obtaining component 212, selection component 214, configuration component 216 and/or execution component 220. Using these components, and using operation of a DAC 313 of qubit control electronics 308 of the quantum system 301, the qubit control electronics management system 202 can generally determine an operating frequency (OF) 386 at which to operate an oscillator 309 of the qubit control electronics 308, and further can compile an intermediate frequency (IF) 284 for use with the OF 386 to generate a resonating frequency (RF) 282 that can provide for sufficient control relative to a qubit 307 (e.g., for driving the qubit 307 and/or for accessing a readout resonator associated with the qubit 307).

Discussion first turns briefly to the processor 206, memory 204 and bus 205 of the qubit control electronics management system 202. For example, in one or more embodiments, the qubit control electronics management system 202 can comprise the processor 206 (e.g., computer processing unit, microprocessor, classical processor, quantum processor and/or like processor). In one or more embodiments, a component associated with qubit control electronics management system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the obtaining component 212, selection component 214, configuration component 216 and/or execution component 220.

In one or more embodiments, the qubit control electronics management system 202 can comprise the computer-readable memory 204 that can be operably connected to the processor 206. The memory 204 can store computer-executable instructions that, upon execution by the processor 206, can cause the processor 206 and/or one or more other components of the qubit control electronics management system 202 (e.g., obtaining component 212, selection component 214, configuration component 216 and/or execution component 220) to perform one or more actions. In one or more embodiments, the memory 204 can store computer-executable components (e.g., obtaining component 212, selection component 214, configuration component 216 and/or execution component 220).

The qubit control electronics management system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the qubit control electronics management system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the qubit control electronics management system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the qubit control electronics management system 202 and the quantum system 301.

In addition to the processor 206 and/or memory 204 described above, the qubit control electronics management system 202 can comprise one or more computer and/or machine readable, writable and/or executable components and/or instructions that, when executed by processor 206, can provide performance of one or more operations defined by such component and/or instruction.

Discussion next turns to the additional components of the qubit control electronics management system 202 (e.g., obtaining component 212, selection component 214, configuration component 216 and/or execution component 220).

Turning first to the obtaining component 212, the obtaining component 212 can generally find, locate, determine, request, download, read and/or otherwise obtain a relative resonant frequency, e.g., a qubit resonant frequency of a qubit 307, or a readout resonant frequency of a readout resonator associated with the qubit 307, to thereby use the qubit resonant frequency to setup qubit control electronics 308 that are communicatively coupled to physical hardware of the qubit 307 for controlling the qubit 307 and/or a readout resonator associated therewith. That is, the setup of the qubit control electronics 308 can be based on the qubit resonant frequency or readout resonator resonant frequency obtained by the obtaining component 212. Information defining the qubit resonant frequency can be transmitted to and/or obtained by any other component of the qubit control electronics management system 202, such as the selection component 214 and/or the configuration component 216.

In one or more embodiments, the qubit resonant frequencies of one or more qubits of a quantum payload (e.g., of a quantum processor 306) of the quantum system 301 can be stored at a database in any suitable location and in any suitable format, such as a lookup table.

In one or more embodiments, a qubit control electronics 308 can control one qubit 307/readout resonator or more than one qubit 307/readout resonator. In one or more embodiments, a qubit 307/readout resonator can be communicatively coupled to one qubit control electronics 308 or more than one qubit control electronics 308.

Next, prior to discussion of use of the resonant frequency obtained by the obtaining component 212, and thus of one or more processes that can be performed by the selection component 214 and/or configuration component 216 relative to the qubit control electronics 308, discussion first turns to a general description of an exemplary quantum system 301 that can comprise the qubit control electronics 308.

Turning to FIG. 3, one or more embodiments described herein can include one or more devices, systems and/or apparatuses that can provide a process to generate one or more waveforms or pulses for a quantum-based operation (e.g., using a quantum device), such as for operating one or more qubits of a quantum device. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100 and/or 200.

As illustrated at FIG. 3, the non-limiting system 300 can comprise a quantum system 301 that can be employed with or separate from the classical systems 102/202.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as an orchestrator component 303, a quantum processor 306, pulse component (e.g., a waveform generator 310) and/or a readout electronics 312 (e.g., readout component).

The quantum processor 306 can comprise one or more, such as plural, qubits 307.

Individual qubits 307A, 307B and 307C, for example, can be fixed frequency and/or single junction qubits, such as transmon qubits.

In one or more embodiments, a readout resonator can be associated with, such as located with physical hardware defining a qubit 307.

In one or more embodiments, a memory 316 and/or processor 314 can be associated with the orchestrator component 303, where suitable. The processor 314 can be any suitable processor. The processor 314 can generate one or more instructions for controlling the one or more processes of the orchestrator component 303, such as for controlling one or more subordinate controllers (e.g., qubit control electronics 308).

The orchestrator component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical systems 102/202.

The orchestrator component 303 can determine mapping of one or more quantum logic circuits for executing a quantum program. In one or more embodiments, the orchestrator component 303 and/or quantum processor 306 can direct the waveform generator 310 to generate one or more pulses, tones, waveforms and/or the like to affect one or more qubits 307, such as in response to a quantum job request 324.

In one or more embodiments, more than one orchestrator component 303 can be comprised by the quantum system 301.

The one or more orchestrator components 303 can be employed to control one or more qubit control electronics 308. Thus, the one or more qubit control electronics 308 can be communicatively coupled to the one or more orchestrator components 303.

Qubit control electronics 308 can be employed by the quantum processor 306 and disposed within a room temperature environment external to the cryogenic environment 317, as illustrated. In one or more embodiments, one or more aspects of one or more qubit control electronics can be disposed within a cryogenic environment 317.

In one or more embodiments a qubit control electronics 308 can be provided per qubit 307. In one or more embodiments, a qubit control electronics 308 can be provided to communicate with more than one qubit 307 per that qubit control electronics 308.

In one or more embodiments, a qubit control electronics 308 can be and/or can comprise a qubit drive card (e.g., a waveform generator 310) and/or a qubit acquire card (e.g., readout electronics 312).

In one or more embodiments, a qubit control electronics 308 can be and/or can comprise only one of a qubit drive card or a qubit acquire card. In one or more embodiments, a qubit control electronics 308 can comprise more than one qubit drive card and/or more than one qubit acquire card.

A waveform generator 310 can generally cause at least one qubit 307 of the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301. Indeed, a signal can be generated by the waveform generator 310 to affect one or more of the plurality of qubits 307.

In one or more embodiments, the waveform generator 310 can direct application of such electro-magnetic signal by use of the various qubit control electronics 308.

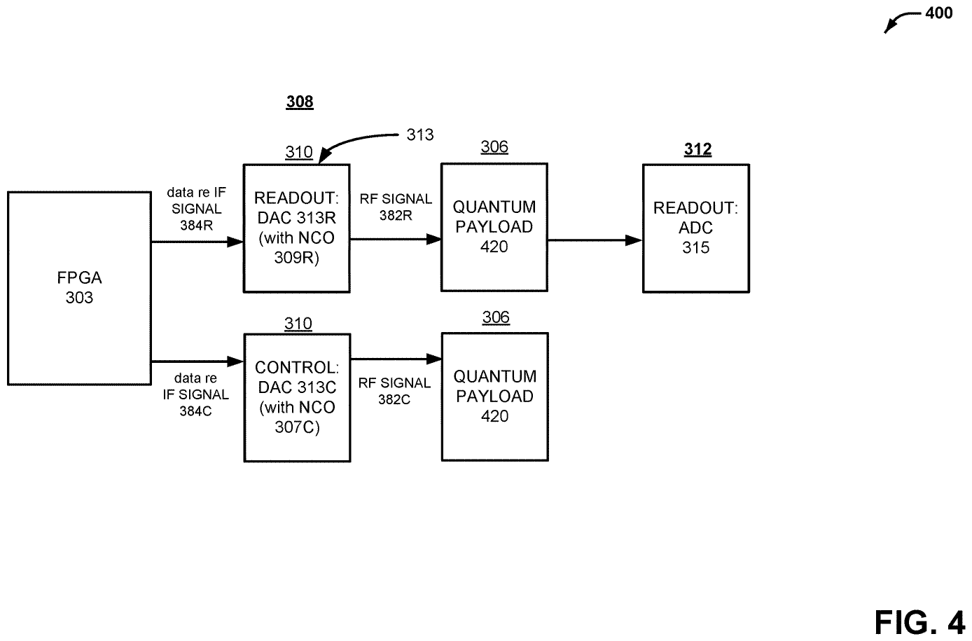

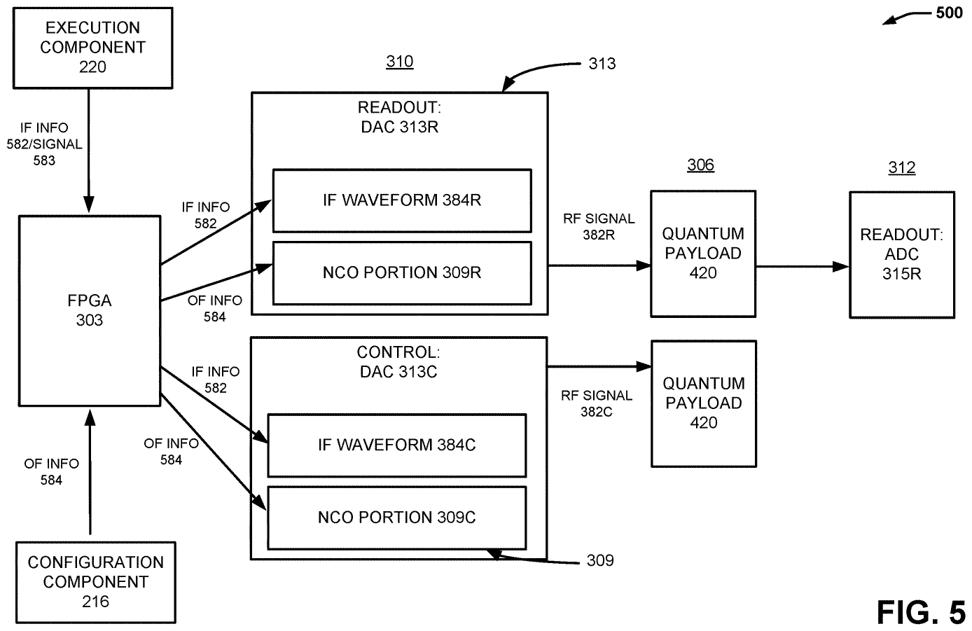

In one or more embodiments (see, e.g., FIG. 4), a qubit control electronics 308 can be and/or can comprise a digital to analog converter (DAC) 313 having a built-in oscillator 309 such as a numerically controlled oscillator (NCO) 309. For example, in one or more embodiments (see, e.g., FIG. 5) a qubit drive card (e.g., a waveform generator 310) can comprise a DAC 313 having a built-in oscillator 309 such as a numerically controlled oscillator (NCO) 309.

For example, in one or more embodiments, a single DAC 313 can be employed for both a control path and a readout path of one or more qubits 307.

In one or more embodiments, qubit control electronics 308 can comprise a pair of DACs 313 (e.g., such as a DAC 313R and a DAC 313C, where the DAC 313R can be employed at a readout path and the DAC 313C can be employed at a control path for control of one or more qubits 307).

In the one or more embodiments of a single DAC 313 or a pair of DACs 313C and 313R, any of these DACs 313 can comprise a built-in oscillator 309, such as a numerically controlled oscillator (NCO) 309. Briefly, this can allow for any one or more of direct generation and transmission of resonating frequencies (RFs) to qubits and/or to readout resonators associated with the qubits, reduced use of real estate in control electronics space of a quantum system, increased density, reduced cabling, and/or reduced card footprint used by individual qubit control electronics (as compared to existing frameworks), and/or reduction in and/or omission of separate oscillator components as a cost-saving mechanism.

The quantum processor 306 can be contained in a cryogenic environment, such as generated by a cryogenic environment 317, such as effected by a dilution refrigerator. Where the plurality of qubits 307 are superconducting qubits, cryogenic temperatures, such as about 4K or lower, can be employed for function of these physical qubits.

The readout electronics 312 can comprise and/or be comprised by the acquire card. The readout electronics 312 and/or the acquire card can comprise an analog to digital converter (ADC) 315 that can be employed for the readout path of one or more qubits 307. The readout electronics 312, or at least a portion thereof, can be contained in a room temperature environment or the cryogenic environment 317, such as for reading a state, frequency and/or other characteristic of qubit, excited, decaying or otherwise. Accordingly, one or more elements of the readout electronics 312 also can be constructed to perform at such cryogenic temperatures.

In one or more embodiments, more than one cryogenic environment, such as more than one dilution refrigerator, can be comprised by the quantum system 301.

It is noted that one or more aspects of the aforementioned description refers to the operation of a single set of instructions run on a single qubit controller or set of qubit control electronics. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning now back to FIG. 2 in addition to still referring to FIG. 3, discussion turns to one or more processes performed by the selection component 214 and configuration component 216.

Generally, the selection component 214 can, on a per qubit basis, define a resonating frequency (RF) 282, wherein the RF 282 is selected to correspond to a qubit 307 (e.g., such as to correspond to a resonant frequency relating to the qubit 307, such as the qubit resonant frequency or the readout resonator resonant frequency). That is, as used here, “to correspond to” can comprise direct correspondence to a qubit resonating frequency of the qubit 307 or to a readout resonator resonating frequency of a readout resonator associated with the qubit 307. That is, the RF 282 selected can, after being generated, be transmitted to qubit control electronics 308 to perform one or more driving operations and/or acquiring operations at and/or relative to the qubit 307.

However, first, the configuration component 216 generally can direct setting of an operating frequency (OF) 386 of an oscillator 309 of the qubit control electronics 308 based on the RF 282. That is, the configuration component 216 can direct the DAC 313, NCO 309 and/or another component of the quantum system 301, such as the orchestrator component 303, to set the NCO 309. The OF 386 can be determined by input from a user entity and/or by the configuration component 216, such that the associated DAC 313 can run at the selected RF 282 to output an RF signal 382 having the RF 282.

In one or more embodiments, the configuration component 216 further can direct setting of a sideband setting of a sideband of the DAC 313 that is associated with the NCO 309. The is the sideband setting can be determined by input from a user entity and/or by the configuration component 216. For example, as part of direct digital synthesis using the DAC 313 to digitally upconvert an IF signal 384, the DAC 313 can determine which side of the NCO 309 to convert to. That is, the DAC 313 can combine the sinusoids I/Q components in a way to cancel out the upper or lower side band. This process is known as single side band cancellation. The DAC 313 thus can convert to NCO OF+IF (upper sideband) or NCO OF−IF (lower sideband).

It is noted that input from a user entity can be made to any component, device, system and/or the like of the non-limiting system 200, such as to a device a communicatively coupled to the classical system 202 or to the quantum system 301.

Next, using the set OF 386 of the NCO 309, the DAC 313 generally can determine the intermediate frequency (IF) 284 for the IF signal 384 that combined with the OF 386 of the oscillator 386 (e.g., by the DAC 313) can enable generation of an RF signal 382, by the DAC 313, with the RF signal 382 having the RF 282.

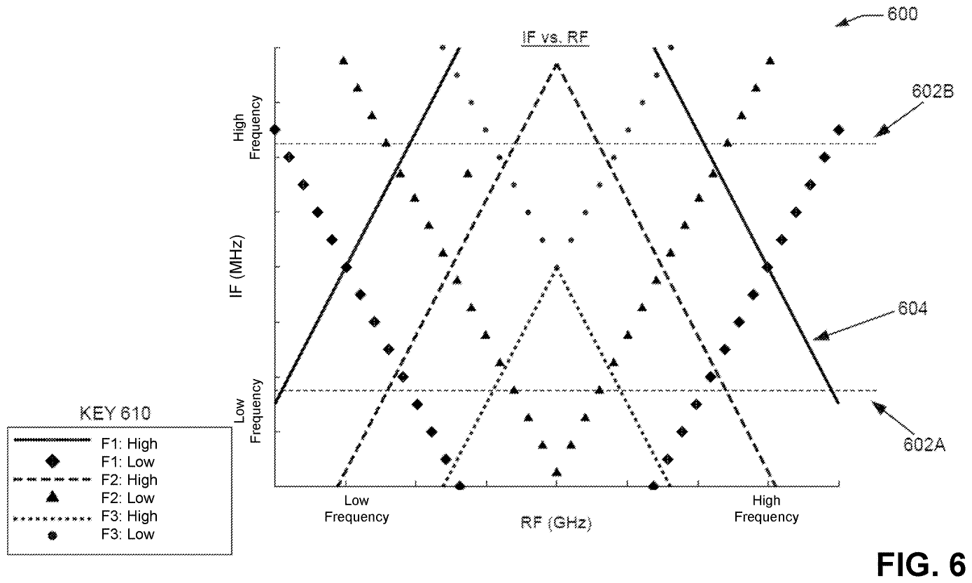

Turning briefly to FIG. 6, an element of selection of the IF 284 that can be determined by a user entity or by the DAC 313 is a range of possible IFs that are optimal As used here, “optimal” can mean that based on a sampling rate of the DAC 313, an RF 282 can be generated having sufficient samples within a period of the IF as determined by the frequency of the IF 284.

As illustrated at graph 600 of FIG. 6, the lines 604 represent different possible NCO settings in the GHz range. Thus, graph 600 graphs possible output RFs 282 (GHz) on the x-axis against possible IFs 284 (MHz) on the y-axis. Intersections of any possible RF 282 with NCO lines are possible combining strategies. For example, a vertical line drawn at an RF of f0 intersects the NCO setting lines 604 four times. However, only two of the intersections are between the boundary lines 602A and 602B. Boundary lines 602A and 602B represent boundaries between which an optimal sampling can be provided, e.g., without too few samples per period of the IF. For example, as the IF frequency increases, the number of samples in a period decreases.

The graph 600 at FIG. 6 visually illustrates one or more processes that can be performed by a user entity and/or by the DAC 313. However, the graph need not be generated by the DAC 313 to perform IF selection.

Regarding the boundary lines 602A and 602B, these thresholds can be selected by the DAC 313 and/or can be assigned by a user entity with information defining the thresholds being transmitted to and/or made available to the DAC 313.

Referring again to operation of the DAC 313 to select the IF 284, in one or more embodiments, a set of steps as follows can be employed, based on the determined and desired RF 382, OF 386 and associated sideband:

```
if RF < Fs: #control DAC range (second Nyquist zone)
  if sideband == ‘UPPER’:
    IF = RF − OF
  else:
    IF = OF − RF
else: #readout DAC range (third Nyquist zone)
  if sideband == ‘UPPER’:
    IF = (2*Fs) − (OF + RF)
  else:
IF = (OF + RF) − (2*Fs).
```

Turning again back to FIG. 2, to facilitate operation of a quantum job request 324 (e.g., whether for calibration, execution of a quantum circuit, and/or other purpose), the execution component 220 generally can direct transmission of a signal 583 (FIG. 5) comprising data (e.g., IF information 582) defining the IF 284 to the DAC 313 comprising the oscillator 309. For example, the execution component 220 can send a signal 583 comprising IF information 582 defining construction of the IF 284. This signal 583 can be sent to the quantum system 301, such as to the orchestrator component 303 and/or to the respective DAC 313.

Turning now to FIGS. 4 and 5, illustrated are processes that are facilitated by the aforementioned operations performed by the classical system 202 and DAC 313.

That is, first, more particularly, the orchestrator component 303, such as comprising a field programmable gate array (FPGA) or a separate FPGA 303 of the quantum system 301 can receive/obtain the IF information 582 from the execution component 220 and can send a signal 583 (same or different signal 583) comprising the IF information 582 defining construction of the IF 284 to the DAC 313.

As illustrated at FIG. 5, this process can be performed on the readout side or on the control side of the respective qubit control electronics 308. That is, the IF information 582 can be sent to the DAC 313R of the readout side (e.g., acquiring side) or to the DAC 313C of the control side (e.g., driving side).

Using the IF information 582, the DAC 313 can construct the IF 284 and combine the IF 284 with the OF 286. Based on the combining performed, the DAC 313 can generate an RF signal 382 having the RF 282 previously determined by the selection component 214. That is, as described above, working backwards from a desired output RF 282, the RF 282 can be generated based on the IF 284, OF 286 and sideband (and based on the processes performed by the classical system 202 and the DAC 313). The RF signal 284 can be output to the quantum payload 420 (e.g., comprising the qubits 307 of the quantum processor 306). That is, the RF signal 382 can be output to a qubit 307 controlled by the qubit control electronics 308, such as to the qubit 307 directly or to a readout resonator associated with the qubit 307.

For example, as illustrated at both FIGS. 4 and 5, the RF signal generated can be a driving RF signal 382C that is output to the qubit 307 (e.g., to the physical hardware of the qubit 307), such as to affect a change of state of the qubit 307.

Alternatively, as also illustrated at both FIGS. 4 and 5, the RF signal generated can be an acquiring RF signal 382R that is output to a readout resonator associated with the qubit 307 such as to affect measurement of the state of the qubit 307.

In this readout side example, a readout analog to digital converter (ADC) 315R can obtain a signal from the quantum payload 420/qubit 307 based on the RF signal 382R transmitted to the quantum payload 420/qubit 307. In one or more embodiments, the ADC 315R can be comprised by and/or associated with the respective readout electronics 312 of the particular qubit control electronics 308. Based on the signal received by the ADC 315R, a quantum measurement readout 320 can be transmitted by the quantum system 301 to the classical system 202 and/or obtained by the classical system 202 from the quantum system 301.

Referring now generally to an aggregation of the processes identified above as being able to be performed by the qubit control electronics management system 202 and the DAC 313, such processes can be performed at least partially in parallel with one another for various other qubit control electronics 308 of the quantum system. Indeed, different qubits 307/readout resonators can have different resonant frequencies. Thus, separately or at least partially in parallel with one another, different OFs 386, IFs 384 and RFs 382 can be determined and/or generated relative to the different qubits 307/readout resonators of a same quantum system 301, such as using the same qubit control electronics management system 202 and the different respective DACs 313.

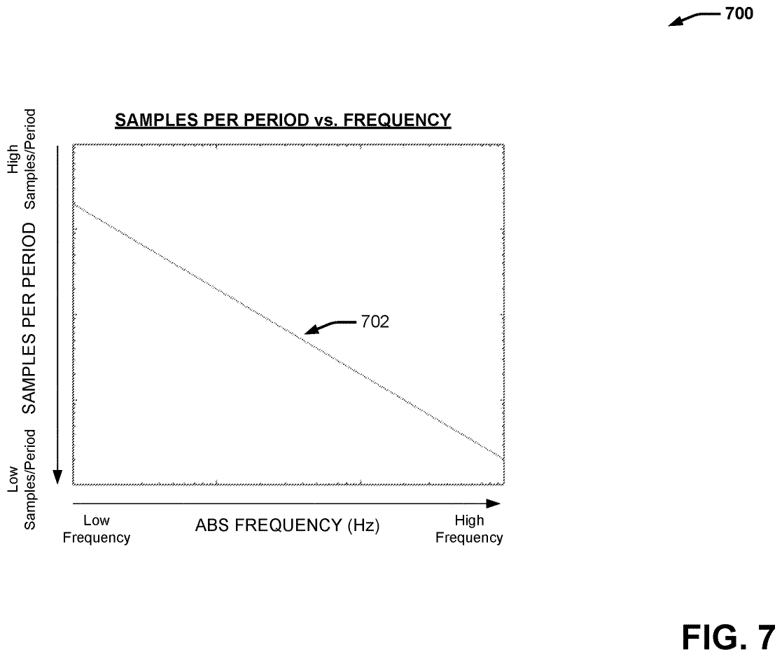

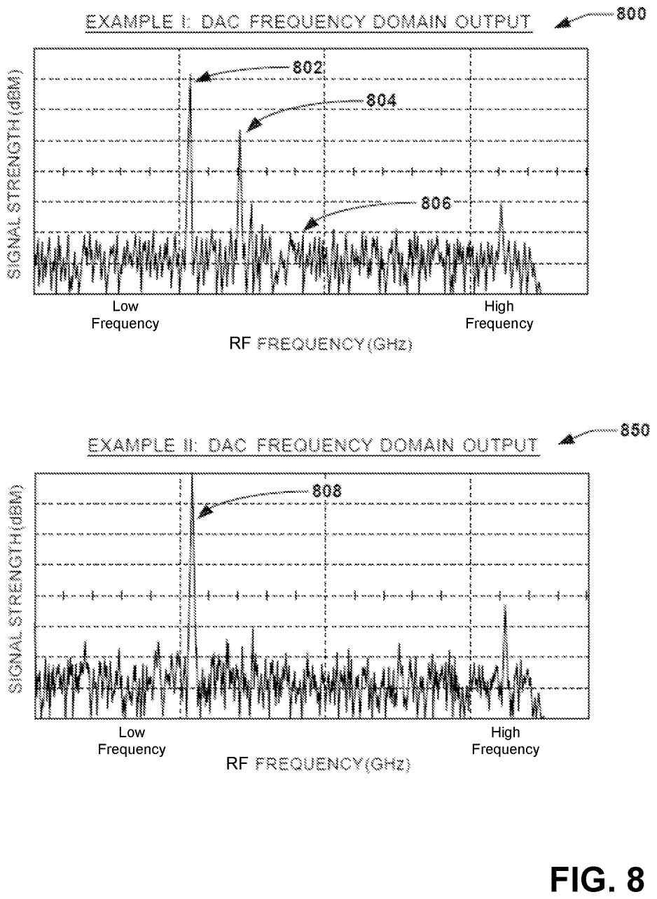

Turning now to FIGS. 7 and 8, illustrated are various graphs providing further explanation of the processes and functions described above as being performed by the non-limiting system 200 (but also applicable to the non-limiting system 100), and/or of the results of the processes and functions described above.

Graph 700 at FIG. 7 illustrates effect of the Nyquist rate with samples per period on the y-axis and absolute value of frequencies (ABS) on the x-axis. The use of ABS can account for negative frequencies. The samples per period refers to the number of samples in a single period of a sinusoid oscillating at a given ABS frequency of the x-axis.

If observing the IF generally (e.g., prior to final generation by the DAC 313), as IF increases for a respective DAC 313, the amount of samples per period drop. Indeed, approaching the Nyquist Rate and/or high frequencies, there are very few samples because the line 702 defining samples per period vs. frequency linearly drops off. Accordingly, selection of the set of frequencies 270, and of a single frequency of the set 270, by the selection component 214, can allow for maintaining distance from a respective Nyquist limit and limiting and/or preventing related Nyquist roll off.

FIG. 8 illustrates a pair of graphs 800 and 850 demonstrating a difference between use of a higher IF (at graph 800) and use of a lower IF (at graph 850). At graph 800, a first GHz RF pulse is generated by a DAC 313 using a first GHz OF of the NCO 309, which requires a first IF 286 in MHz, as determined by the DAC 313. In the illustrated graph 800 of the frequency domain spectrum produced by the DAC 313, there is some noise 806 along with an extraneous peak 804 (e.g., adjacent the RF pulse generated) that is not the RF pulse generated. At graph 850 a same first GHz RF pulse is generated by a DAC 313 using a second and lower GHz OF of the NCO 309 (e.g., lower than the first GHz OF), which requires a second IF 286 in the MHz range, as determined by the DAC 313. The second IF 286 is lower, such as significantly lower, than the first IF 286. In the illustrated graph 850 of the frequency domain spectrum produced by the DAC 313, there is some noise 806, but there is not an extraneous peak adjacent the RF pulse generated.

That is, to summarize, as shown, both first and second IFs can provide a high signal strength (dBM) RF peak (peaks 802 and 808), with additional noise 806. However, use of a lower IF (at graph 850 being the 200 MHz IF) can result in better spectral content due to omission/lack of extraneous harmonics (e.g., extraneous harmonic 804 of graph 800) adjacent the RF peak 808.

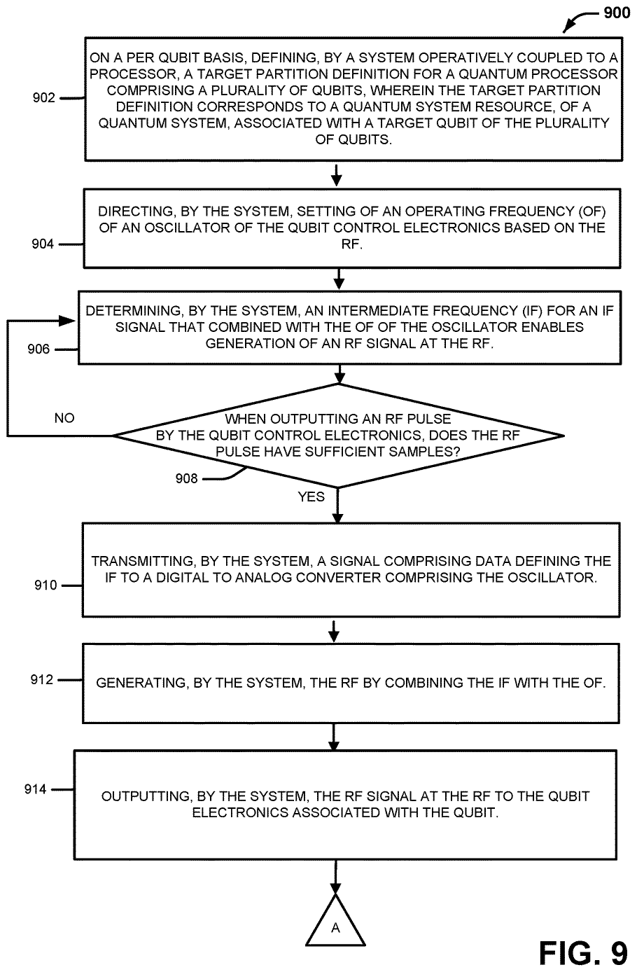

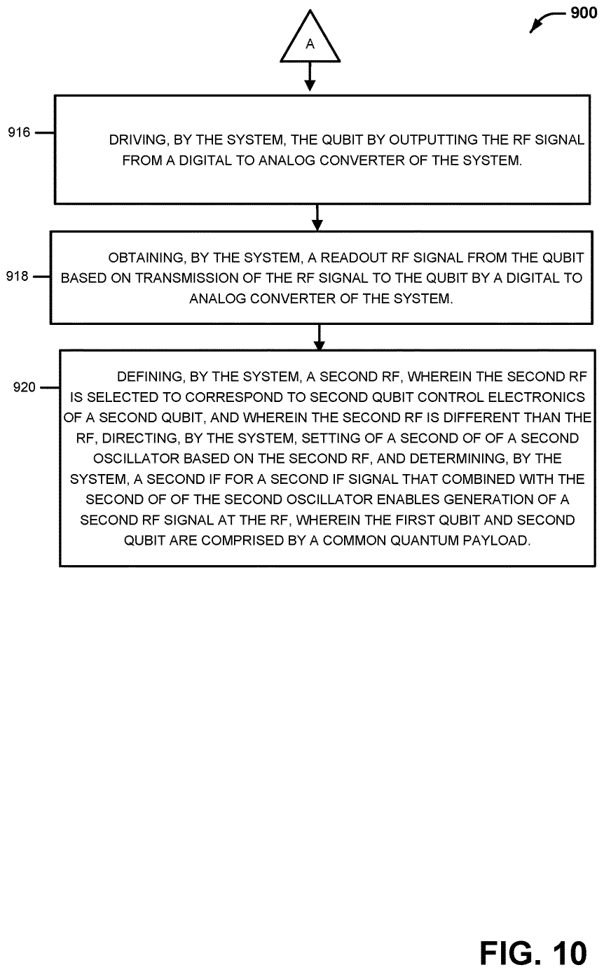

As additional summary, referring next to FIGS. 9 and 10, illustrated is a flow diagram of an example, non-limiting method 900 that can provide a process to setup quantum system resources, such as qubit control electronics (e.g., qubit control electronics 308) of a quantum system (e.g., quantum system 301), in accordance with one or more embodiments described herein, such as the non-limiting system 200 of FIG. 2. While the non-limiting method 900 is described relative to the non-limiting system 200 of FIG. 2, the non-limiting method 900 can be applicable also to other systems described herein, such as the non-limiting system 100 of FIG. 1. Repetitive description of like elements and/or processes employed in respective embodiments is omitted for sake of brevity.

At 902, the non-limiting method 900 can comprise, on a per qubit basis, defining, by a system operatively coupled to a processor (e.g., selection component 214), wherein an RF (e.g., RF 182, 282) is selected to correspond to a qubit (e.g., qubit 307).

At 904, the non-limiting method 900 can comprise directing, by the system (e.g., configuration component 216), setting of an operating frequency (OF) (e.g., OF 286) of an oscillator (e.g., oscillator 309) of qubit control electronics (e.g., qubit control electronics 208) based on the RF.

In one or more embodiments, an oscillator is a free running oscillator or free running numerically controlled oscillator.

In one or more embodiments, the oscillator is built into a digital to analog converter (e.g., DAC 313) of the qubit control electronics.

At 906, the non-limiting method 900 can comprise determining, by the system (e.g., digital to analog converter (DAC) 313 of quantum system 301), an intermediate frequency (IF) (e.g., IF 184, 284) for an IF signal (e.g., IF signal 384) that combined with the OF of the oscillator enables generation of an RF signal (e.g., RF signal 382) at the RF.

At 908, the non-limiting method 900 can comprise determining, by the system (e.g., configuration component 216), whether, when outputting the RF signal (e.g., RF signal 382) by the qubit control electronics, the RF signal has sufficient samples. If yes, the non-limiting method 800 can proceed to step 810. If no, the non-limiting method can instead proceed back to step 806 to better determine a the IF 284.

At 910, the non-limiting method 900 can comprise transmitting, by the system (e.g., execution component 220), a signal (e.g., signal 583) comprising data (e.g., data 582) defining the IF to a digital to analog converter (e.g., DAC 313) comprising the oscillator.

At 912, the non-limiting method 900 can comprise generating, by the system (e.g., DAC 313) the RF by combining the IF with the OF.

At 914, the non-limiting method 900 can comprise outputting, by the system (e.g., DAC 313), the RF signal at the RF to the qubit electronics associated with the qubit.

At 916, the non-limiting method 900 can comprise driving, by the system (e.g., DAC 313), the qubit by outputting the RF signal from a digital to analog converter of the system.

At 918, the non-limiting method can comprise obtaining, by the system (e.g., DAC 313), a readout RF signal (e.g., signal 382R) from the qubit based on transmission of the RF signal to the qubit by a digital to analog converter of the system.

At 920, the non-limiting method 900 can comprise defining, by the system (e.g., selection component 214), a second RF, wherein the second RF is selected to correspond to second qubit control electronics of a second qubit, and wherein the second RF is different than the RF, directing, by the system (e.g., configuration component 216), setting of a second OF of a second oscillator based on the second RF, and determining, by the system (e.g., DAC 313) a second IF for a second IF signal that combined with the second OF of the second oscillator enables generation of a second RF signal at the RF, wherein the first qubit and second qubit are comprised by a common quantum payload.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system, computer-implemented method and/or computer program product to provide for control of a quantum system 301 through use of one or more digital to analog converters comprising built-in oscillators. A system 100, 200 comprises a memory 104, 204 that stores and a processor 106, 206 that executes computer executable components stored in the memory 104, 204, wherein the computer executable components comprise a selection component 114, 214 that, on a per qubit basis, defines a resonating frequency (RF) 182, 282, wherein the RF 182, 282 is selected to correspond to a qubit 307 of a quantum system 301, a configuration component 116, 216 that directs setting of an operating frequency (OF) 386 of an oscillator 309 of qubit control electronics 308, associated with the qubit 307, based on the RF 182, 282, and a digital to analog converter (DAC) 313, of the qubit control electronics 308, that determines an intermediate frequency (IF) 184, 284 for an IF signal 384 that combined with the OF 386 of the oscillator 309 enables generation of an RF signal 382 having the RF 182, 282.

A benefit of the system, computer-implemented method and/or computer program product can be an ability to, during quantum system setup, configure qubit control electronics to function with qubits having varying resonant frequencies, including atypical frequencies. This setup of the qubit control electronics can be provided while also employing resonant frequency outputs from the control electronics that can allow for adequate sampling, sufficient to determine accurate qubit states. That is, signals sent from and obtained by qubit control electronics can have better spectral content and reduced extraneous harmonic peaks than those sent from and obtained by qubit control electronics setup using existing frameworks.

Another benefit of the system, computer-implemented method and/or computer program product can be an ability to employ a digital to analog converter (DAC) comprising a built-in oscillator, such as a free running numerically controlled oscillator (NCO).

Yet another benefit of the system, computer-implemented method and/or computer program product can be an ability to obtain improved performance of a larger quantity of qubits of a single quantum system that is possible using existing frameworks. This improved performance can be obtained over a wider qubit resonant frequency range, thus allowing for more headroom for future larger quantum payloads.

Still another benefit of the system, computer-implemented method and/or computer program product described herein can generally be an improvement in the functioning of a quantum computer, such as related to initialization, calibration and/or execution of a quantum payload of a quantum system. This improvement improves the function of a quantum computer relative to existing quantum systems. Indeed, for a non-limiting system comprising both a classical system as described herein and a quantum system as described herein (e.g., comprising a quantum computer), such non-limiting system can be self-improving due to the initial setup of quantum system resources (e.g., qubit control electronics) performed, by allowing for more accurate, more precise and/or more efficient subsequent initialization, calibration and/or execution of a quantum payload.

Indeed, in view of the one or more embodiments described herein, a practical application of the one or more systems, computer-implemented methods and/or computer program products described herein can be an ability to control an increasingly large quantum payload and/or an overall increasingly wide resonant frequency range as compared to existing framework.

In connection therewith, the one or more embodiments described herein can provide useful and practical applications of computers, thus providing enhanced (e.g., improved and/or optimized) quantum system setup as compared to existing frameworks. Overall, such computerized tools can constitute a concrete and tangible technical improvement in the field of quantum processing.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to quantum payload control and/or control setup, as compared to existing systems and/or techniques unable to provide quantum payload control and/or control setup. Systems, computer-implemented methods and/or computer program products providing performance of these processes are of great utility in the fields of quantum computing and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically perform quantum control electronics setup as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, comprising: a memory that stores computer executable components; and a processor that executes the computer executable components stored in the memory, wherein the computer executable components comprise: a selection component that, on a per qubit basis, defines a resonating frequency (RF), wherein the RF is selected to correspond to a qubit of a quantum system; a configuration component that directs setting of an operating frequency (OF) of an oscillator of qubit control electronics, associated with the qubit, based on the RF; and a digital to analog converter (DAC), of the qubit control electronics, that determines an intermediate frequency (IF) for an IF signal that combined with the OF of the oscillator enables generation of an RF signal having the RF.

The system of the preceding paragraph, further comprising: an execution component that directs transmission of a signal comprising data defining the IF to the DAC comprising the oscillator.

The system of any preceding paragraph, wherein the oscillator is a free running numerically controlled oscillator (NCO).

The system of any preceding paragraph, wherein the DAC comprises the oscillator and combines the IF with the OF of the oscillator.

The system of any preceding paragraph, wherein the DAC comprises the oscillator and outputs the RF signal at the RF to the qubit.

The system of any preceding paragraph, wherein the DAC comprises the oscillator and drives the qubit by outputting the RF signal.

The system of any preceding paragraph, further comprising: an analog to digital converter (ADC) that obtains a readout RF signal from the qubit based on transmission of the RF signal to the qubit by the DAC.

The system of any preceding paragraph, wherein the selection component defines a second RF, wherein the second RF is selected to correspond to second qubit control electronics of a second qubit, and wherein the second RF is different than the RF; wherein the configuration component directs setting of a second OF of a second oscillator based on the second RF; and wherein a second DAC determines a second IF for a second IF signal that combined with the second OF of the second oscillator enables generation of a second RF signal at the RF, wherein the first qubit and second qubit are comprised by a common quantum payload.

A computer-implemented method, comprising: on a per qubit basis, defining, by a system operatively coupled to a processor, a resonating frequency (RF), wherein the RF is selected to correspond to a qubit; directing, by the system, setting of an operating frequency (OF) of an oscillator of the qubit control electronics based on the RF; and determining, by the system, an intermediate frequency (IF) for an IF signal that combined with the OF of the oscillator enables generation of an RF signal at the RF.

The computer-implemented method of the preceding paragraph, further comprising: transmitting, by the system, a signal comprising data defining the IF to a digital to analog converter comprising the oscillator.

The computer-implemented method of any preceding paragraph, wherein the oscillator is a free running numerically controlled oscillator (NCO).

The computer-implemented method of any preceding paragraph, further comprising: generating, by the system, the RF by combining the IF with the OF.

The computer-implemented method of any preceding paragraph, further comprising: outputting, by a digital to analog converter of the system, the RF signal at the RF to the qubit.

The computer-implemented method of any preceding paragraph, further comprising: driving, by the system, the qubit by outputting the RF signal from a digital to analog converter of the system.

The computer-implemented method of any preceding paragraph, further comprising: obtaining, by an analog to digital converter of the system, a readout RF signal from the qubit based on transmission of the RF signal to the qubit by a digital to analog converter of the system.

The computer-implemented method of any preceding paragraph, further comprising: defining, by the system, a second RF, wherein the second RF is selected to correspond to second qubit control electronics of a second qubit, and wherein the second RF is different than the RF; directing, by the system, setting of a second OF of a second oscillator based on the second RF; and determining, by the system, a second IF for a second IF signal that combined with the second OF of the second oscillator enables generation of a second RF signal at the RF, wherein the first qubit and second qubit are comprised by a common quantum payload.

A computer program product facilitating a process to control a quantum payload comprising a qubit, the computer program product comprising a computer readable storage medium having program instructions embodied therewith, the program instructions executable by a processor to cause the processor to:on a per qubit basis, define, by the processor, a resonating frequency (RF), wherein the RF is selected to correspond to the qubit; direct, by the processor, setting of an operating frequency (OF) of an oscillator of the qubit control electronics based on the RF; and determine, by the processor, an intermediate frequency (IF) for an IF signal that combined with the OF of the oscillator enables generation of an RF signal at the RF.

The computer program product of the preceding paragraph, wherein the program instructions are further executable by the processor to cause the processor to: direct, by the processor, transmission of a signal comprising data defining the IF to a digital to analog converter comprising the oscillator.

The computer program product of any preceding paragraph, wherein the oscillator is a free running numerically controlled oscillator (NCO).

The computer program product of any preceding paragraph, wherein the program instructions are further executable by the processor to cause the processor to: define, by the processor, a second RF, wherein the second RF is selected to correspond to second qubit control electronics of a second qubit, and wherein the second RF is different than the RF; set, by the processor, a second OF of a second oscillator based on the second RF; and determine, by the processor, a second IF for a second IF signal that combined with the second OF of the second oscillator enables generation of a second RF signal at the RF, wherein the first qubit and second qubit are comprised by a common quantum payload.

### Computing Environment Description

Turning next to FIG. 11, a detailed description is provided of additional context for the one or more embodiments described herein at FIGS. 1-10.

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a target system by the DAC setup and/or use code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine that collects and stores helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a selection component that, on a per qubit basis, defines a resonating frequency (RF), wherein the RF is selected to correspond to a qubit of a quantum system;
a configuration component that directs setting of an operating frequency (OF) of an oscillator of qubit control electronics, associated with the qubit, based on the RF; and
a digital to analog converter (DAC), of the qubit control electronics, that determines an intermediate frequency (IF) for an IF signal that combined with the OF of the oscillator enables generation of an RF signal having the RF.

2. The system of claim 1, further comprising:
an execution component that directs transmission of a signal comprising data defining the IF to the DAC comprising the oscillator.

3. The system of claim 1, wherein the oscillator is a free running numerically controlled oscillator (NCO).

4. The system of claim 1, wherein the DAC comprises the oscillator and combines the IF with the OF of the oscillator.

5. The system of claim 1, wherein the DAC comprises the oscillator and outputs the RF signal at the RF to the qubit.

6. The system of claim 1, wherein the DAC comprises the oscillator and drives the qubit by outputting the RF signal.

7. The system of claim 1, further comprising:
an analog to digital converter (ADC) that obtains a readout RF signal from the qubit based on transmission of the RF signal to the qubit by the DAC.

8. The system of claim 1,
wherein the selection component defines a second RF, wherein the second RF is selected to correspond to second qubit control electronics of a second qubit, and wherein the second RF is different than the RF;
wherein the configuration component directs setting of a second OF of a second oscillator based on the second RF; and
wherein a second DAC determines a second IF for a second IF signal that combined with the second OF of the second oscillator enables generation of a second RF signal at the RF,
wherein the first qubit and second qubit are comprised by a common quantum payload.

9. A computer-implemented method, comprising:
on a per qubit basis, defining, by a system operatively coupled to a processor, a resonating frequency (RF), wherein the RF is selected to correspond to a qubit;
directing, by the system, setting of an operating frequency (OF) of an oscillator of the qubit control electronics based on the RF; and
determining, by the system, an intermediate frequency (IF) for an IF signal that combined with the OF of the oscillator enables generation of an RF signal at the RF.

10. The computer-implemented method of claim 9, further comprising:
transmitting, by the system, a signal comprising data defining the IF to a digital to analog converter comprising the oscillator.

11. The computer-implemented method of claim 9, wherein the oscillator is a free running numerically controlled oscillator (NCO).

12. The computer-implemented method of claim 9, further comprising:
generating, by the system, the RF by combining the IF with the OF.

13. The computer-implemented method of claim 9, further comprising:
outputting, by a digital to analog converter of the system, the RF signal at the RF to the qubit.

14. The computer-implemented method of claim 9, further comprising:
driving, by the system, the qubit by outputting the RF signal from a digital to analog converter of the system.

15. The computer-implemented method of claim 9, further comprising:
obtaining, by an analog to digital converter of the system, a readout RF signal from the qubit based on transmission of the RF signal to the qubit by a digital to analog converter of the system.

16. The computer-implemented method of claim 9, further comprising:
defining, by the system, a second RF, wherein the second RF is selected to correspond to second qubit control electronics of a second qubit, and wherein the second RF is different than the RF;
directing, by the system, setting of a second OF of a second oscillator based on the second RF; and
determining, by the system, a second IF for a second IF signal that combined with the second OF of the second oscillator enables generation of a second RF signal at the RF,
wherein the first qubit and second qubit are comprised by a common quantum payload.

17. A computer program product facilitating a process to control a quantum payload comprising a qubit, the computer program product comprising a computer readable storage medium having program instructions embodied therewith, the program instructions executable by a processor to cause the processor to:
on a per qubit basis, define, by the processor, a resonating frequency (RF), wherein the RF is selected to correspond to the qubit;
direct, by the processor, setting of an operating frequency (OF) of an oscillator of the qubit control electronics based on the RF; and
determine, by the processor, an intermediate frequency (IF) for an IF signal that combined with the OF of the oscillator enables generation of an RF signal at the RF.

18. The computer program product of claim 17, wherein the program instructions are further executable by the processor to cause the processor to:
direct, by the processor, transmission of a signal comprising data defining the IF to a digital to analog converter comprising the oscillator.

19. The computer program product of claim 17, wherein the oscillator is a free running numerically controlled oscillator (NCO).

20. The computer program product of claim 17, wherein the program instructions are further executable by the processor to cause the processor to:
define, by the processor, a second RF, wherein the second RF is selected to correspond to second qubit control electronics of a second qubit, and wherein the second RF is different than the RF;
set, by the processor, a second OF of a second oscillator based on the second RF; and
determine, by the processor, a second IF for a second IF signal that combined with the second OF of the second oscillator enables generation of a second RF signal at the RF,
wherein the first qubit and second qubit are comprised by a common quantum payload.
